(19) United States
(12) Patent Application Publication
(10) Pub. No.: US 2026/0092628 A1
(43) Pub. Date: Apr. 2, 2026

(54) Disc Brake for a Commercial Vehicle

(71) Applicant: KNORR-BREMSE Systeme fuer Nutzfahrzeuge GmbH, Muenchen (DE)

(72) Inventors: Thomas BECK, Neukirchen vorm Wald (DE); Michael HIDRINGER, Winzer (DE); Alexander ASEN, Eichendorf (DE); Martin PLEINTINGER, Eichendorf (DE); Martin HEINDL, Eging am See (DE); Matthias ADELUNG, Fuerstenzell (DE); Peter GROSS, Passau (DE)

(21) Appl. No.: 19/339,489

(22) Filed: Sep. 25, 2025

(30) Foreign Application Priority Data
Sep. 27, 2024 (DE) 10 2024 128 046.8

(51) Int. Cl. F16D 65/00; F16D 55/225; F16D 65/40

(52) U.S. Cl. CPC F16D 65/0087; F16D 55/225; F16D 65/40

(57) ABSTRACT

A disc brake has a brake caliper in which two brake pads are arranged so that they can be pressed against a brake disc in operation, one of which on the clamping side is actuatable via at least one axially adjustable adjusting spindle carrying a pressure piece by way of a clamping device and the adjusting spindle being guided through an opening of a closure cover closing a receiving chamber of the brake caliper, thereby forming an annular gap. A sealing arrangement is provided for sealing the receiving chamber in the region of the opening, which sealing arrangement bears, on the one hand, against the pressure piece and, on the other hand, is held at the inner side of a collar that circumferentially delimits the opening and extends axially, the sealing arrangement has a bellows and a concentrically arranged secondary seal, and the secondary seal and the bellows are formed integrally, in such a manner that the secondary seal, which has a central opening and is more dimensionally stable than the bellows, has a circumferential wall which is fastened by frictional engagement or by a material bond to the inside of the collar, the bottom angled relative to the wall of the secondary seal bearing with its edge delimiting the central opening, formed as a bead, against the adjusting spindle, and the bellows being connected, with its end formed as a thickened portion opposite the circumferential wall of the secondary seal, to the pressure piece by positive engagement, material bonding, or frictional engagement.

### CROSS REFERENCE TO RELATED APPLICATION

This application claims priority under 35 U.S.C. § 119 from German Patent Application No. 10 2024 128 046.8, filed Sep. 27, 2024, the entire disclosure of which is herein expressly incorporated by reference.

### BACKGROUND AND SUMMARY

The invention relates to a disc brake for a commercial vehicle.

In order to prevent moisture and dirt from entering the receiving chamber of a brake caliper of a disc brake during vehicle operation, which could lead to corrosion of functionally relevant components arranged in the receiving chamber, including in particular a clamping device, the receiving chamber is substantially closed off on the side which, in a sliding-caliper disc brake, is assigned to the clamping-side brake pad, by a closure cover.

For actuating the brake, at least one adjusting spindle is provided, which is rotatably mounted in a bridge, on which a pneumatically or electromechanically actuable brake lever acts in such a manner that a pressure piece arranged on the adjusting spindle is pressed against the associated brake pad.

The adjusting spindle carrying the pressure piece is guided through an opening in the closure cover, which opening is delimited by a collar oriented axially toward the brake pad. The diameter of the opening in this case is greater than the outside diameter of the adjusting spindle, so that a circumferential annular gap results.

For closing the annular gap, a bellows is provided that bears, on the one hand, against the adjusting spindle or the pressure piece and, on the other hand, is retained in the region of the opening, in particular on the inner circumferential surface of the collar.

A secondary seal, which covers the bellows on the side facing the receiving chamber, forms a redundant sealing element, by which, in the event of possible failure of the bellows, the receiving chamber is protected from coarse dirt.

During braking, the adjusting spindle is displaced in the direction of the brake disc, wherein, with increasing wear of the brake pads, the adjusting spindle is extended further in order to ensure a constant clearance. This movement is compensated by the bellows, in order to guarantee the seal of the receiving chamber.

In this case, the bellows seals at two points: firstly, at the transition to the pressure piece, and secondly, at the transition to the closure cover. The fastening of the bellows to the pressure piece takes place by crimping, while the fastening to the collar of the closure cover is effected by frictional engagement.

However, this requires the observance of very narrow tolerances and a corresponding quality of the closure cover surface.

From the prior art, it is known to form the secondary seal and the bellows as separate parts, wherein the secondary seal covers the bellows on the side facing the arranged brake pad. To prevent radial twisting, the secondary seal is press-fitted onto a collar of a bridge accommodating the adjusting spindle. However, this kind of sealing is disadvantageous both in terms of manufacture and assembly, in particular being cost-intensive.

DE 10 2018 101 288 A1 therefore proposes that the secondary seal and the bellows are formed integrally, although this structural unit is designed in such a manner that it can likewise only be realized with considerable production effort. Moreover, the secondary seal rests with its inner circumferential surface against the outer surface of the collar of the closure cover, a continuation of the circumferential surface being formed by the integrally formed bellows, which is furthermore held at the pressure piece.

In order to achieve sufficient sealing of the annular gap, the secondary seal has a sealing bead filling this annular gap, wherein this sealing bead is arranged in the edge region of the central opening of the secondary seal, which in turn bears against the adjusting spindle.

A comparable sealing arrangement, in which the secondary seal and the bellows are made of an elastic material, is disclosed in WO 2019/137 768 A1. However, this makes the assembly of the sealing arrangement considerably more difficult.

The invention is based on the object of developing a disc brake of the generic kind in such a manner that it can be produced and assembled more easily and cost-effectively.

This object is achieved by a disc brake having the features of the independent claim(s).

Accordingly, the pot-shaped secondary seal, which has a central opening and is more dimensionally stable than the bellows, has a circumferential wall which is fastened by frictional engagement or by a material bond to the inside of the collar delimiting the opening of the closure cover.

The bottom angled relative to the wall, which extends radially towards the adjusting spindle, bears with its edge delimiting the central opening, formed as a bead, against the adjusting spindle. The bellows which, as known from the prior art, is integrally formed with the secondary seal from plastic, is connected, with its end formed as a thickened portion opposite the circumferential wall of the secondary seal, to the pressure piece by positive engagement, material bonding, or frictional engagement.

This structural configuration results in a whole host of advantages. It should be emphasized, for example, that the sealing arrangement as a one-piece structural unit is extremely simple to manufacture, which in turn results in cost minimization.

Equally, the assembly of the sealing arrangement is also significantly simplified, the secondary seal, as mentioned, being more dimensionally stable than the bellows and forming a receiving space for the bellows.

In this case, the sealing arrangement is fastened only at two positions, namely, on the one hand, the bellows to the pressure piece and, on the other hand, the secondary seal to the collar of the closure cover, which extends either axially outwards, i.e. away from the receiving chamber of the brake caliper, or axially inwards towards the receiving chamber. The respective bearing regions of the secondary seal and of the bellows are reinforced, preferably with a metal ring or a plastic ring, the latter being made of a relatively hard plastic.

In order to fasten the bellows to the pressure piece, various configurations of the end region of the bellows are conceivable, the connection to the pressure piece being possible by positive engagement, material bonding, or frictional engagement, material bonding being effected by adhesive bonding. This ensures both axial and radial securing of the bellows, as well as of the secondary seal.

The secondary seal is held on the collar in a rotationally secured manner but allows radial and axial movement of the adjusting spindle, the edge delimiting the central opening and formed as a bead bearing in a sealing manner against the adjusting spindle.

As mentioned, the secondary seal is more dimensionally stable than the bellows, the manufacture of this sealing arrangement being suitable in the known two-component injection molding process.

Further advantageous embodiments of the invention are defined in the dependent claims.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a disc brake according to the prior art as a sectional plan view; and

FIGS. 2 to 7 each show an exemplary embodiment of the invention as part of the disc brake in an enlarged detail view.

### DETAILED DESCRIPTION OF THE DRAWINGS

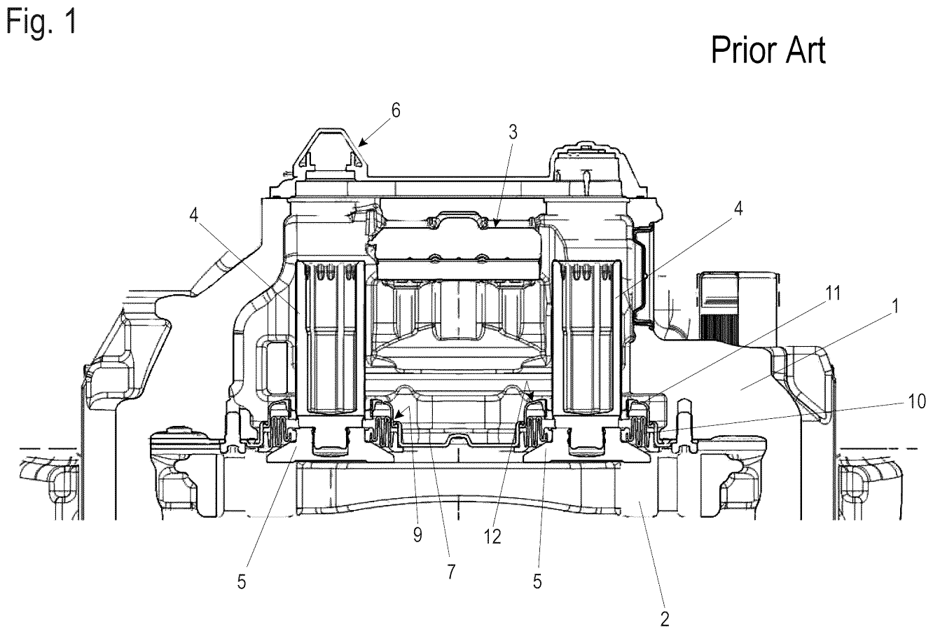

In FIG. 1, a disc brake according to the prior art is shown schematically, with a brake caliper 1 designed as a sliding caliper and straddling a brake disc (not shown), in which two brake pads (likewise not shown) are arranged in a brake carrier 2 and, in operation, i.e. during braking, can be pressed against the brake disc.

In this case, the brake pad on the clamping side is first pressed against the brake disc by means of a clamping device 3, and subsequently, due to the reaction forces resulting from displacement of the brake caliper 1, the brake pad on the reaction side is likewise pressed against the brake disc.

In the example, the clamping device 3 comprises two axially adjustable adjusting spindles 4 arranged parallel to and spaced apart from one another, which are guided through an opening 9 of a closure cover 7 that closes a receiving chamber of the brake caliper 1, thereby forming an annular gap.

For sealing the receiving chamber in the region of each opening 9, a sealing arrangement 12 is provided, which consists of a bellows 10 and a secondary seal 11, which are each formed and fastened separately from one another.

In this case, the secondary seal 11 is held, on the one hand, at the closure cover 7 and, on the other hand, bears against the adjusting spindle 4. The bellows 10 is also held at the closure cover 7, on the one hand, while on the other hand it bears against a pressure piece 5 which is fastened at the end of the adjusting spindle 4 facing the brake pad.

The adjusting spindle 4 is connected to an adjusting device 6, by means of which compensation for wear-induced clearance is possible.

The annular gap formed is closed on its side facing away from the receiving chamber by the bellows 10, which circumferentially surrounds the opening 7 and is held in a sealing manner on a collar integrally formed on the closure cover 7 and extending axially in the direction of the brake pad on the clamping side.

The secondary seal 11 protects the receiving chamber from penetrating dirt in the event that the bellows 10 is damaged and no longer guarantees its protective function.

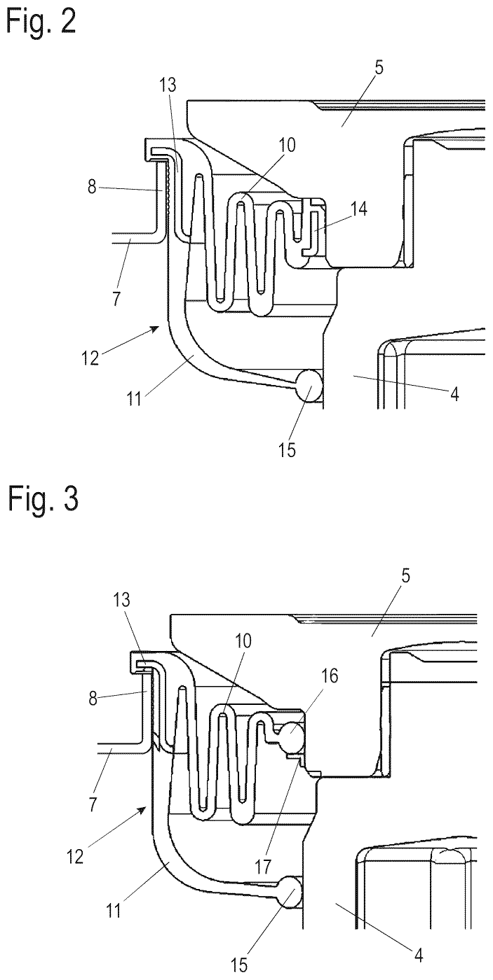

In FIGS. 2 to 7, the sealing arrangement 12 according to embodiments of the invention can be seen in each case as an enlarged partial sectional view which, as mentioned, consists of the bellows 10 and the secondary seal 11, said secondary seal being designed in a pot shape.

With its edge region facing away from the adjusting spindle 4, the secondary seal 11 is fastened by frictional engagement or material bonding to the inner side of the collar 8 and, in any case, secured against rotation relative to the collar 8. For this purpose, a dimensionally stable reinforcement ring 13, preferably made of metal and, in the example, Z-shaped in cross section, is embedded in the edge region. By the applied contact pressure, the secondary seal 11 is held frictionally on the collar 8. The bellows 10 adjoins the secondary seal 11 in this region.

An edge angled relative to the axially extending circumferential surface of the secondary seal 11, delimiting a central opening of the secondary seal 11, is formed as a bead 15 which bears in a sealing manner against the adjusting spindle 4 in such a manner that free rotation and axial movement are possible.

The bellows 10 is connected, by its end formed as a thickened portion opposite the wall of the secondary seal 11, to the pressure piece 5 by positive engagement, material bonding, or frictional engagement.

In the exemplary embodiment shown in FIG. 2, this end is reinforced for this purpose by an embedded support ring 14, J-shaped in cross section, by which frictional engagement with the pressure piece 5 is possible, but which is also suitable for producing an adhesive connection.

In the embodiment shown in FIG. 3, the end of the bellows 10 bearing against the pressure piece 5 is formed as an O-ring 16, which bears against the pressure piece 5 and is secured in the axial direction by a support ring 17, arranged opposite the pressure piece 5 and connected to the pressure piece 5 by frictional engagement or material bonding, the O-ring 16 bearing against the support ring 17.

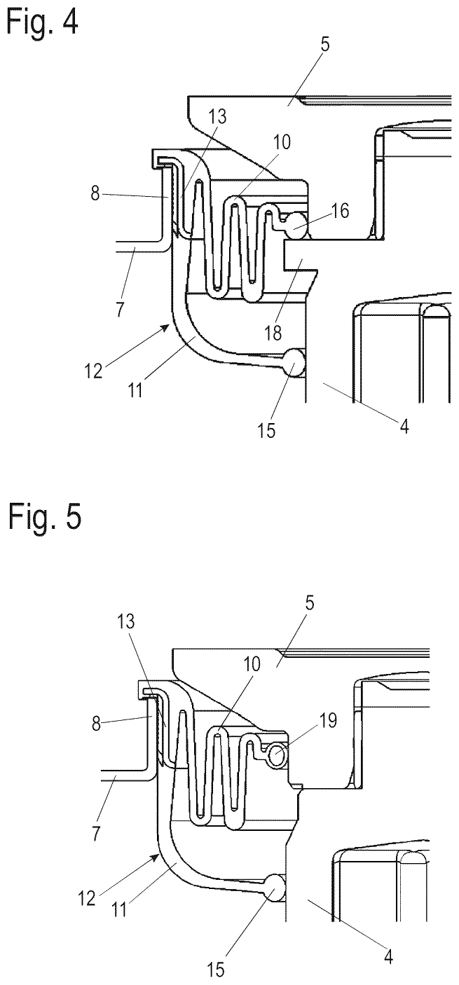

FIG. 4 shows a variant of the fastening of the bellows 10 to the pressure piece 5, in which a collar 18 is integrally formed on the adjusting spindle 4 for axial support of the O-ring 16, which collar likewise serves as a support for the O-ring 16, thereby providing axial securing of the O-ring 16.

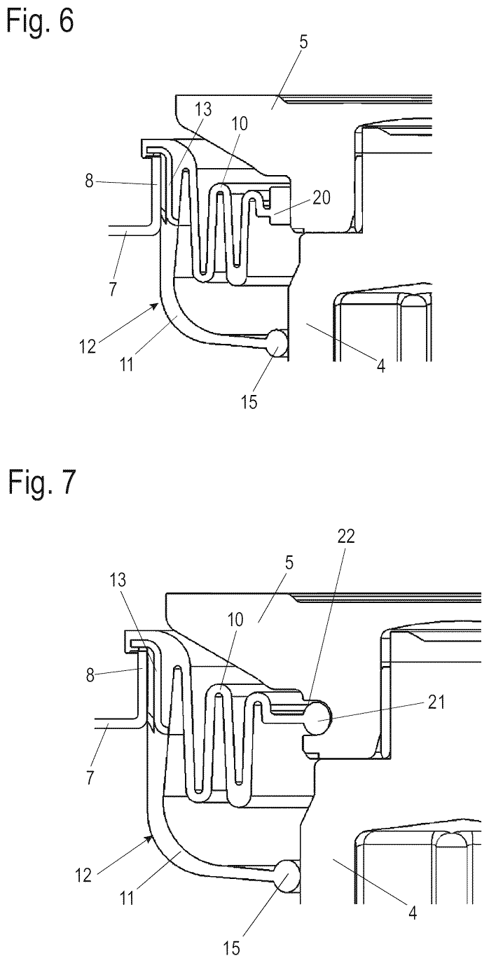

In the example shown in FIG. 5, the connection of the bellows 10 to the pressure piece 5 is effected by an embedded spring or wire ring 19 to produce a frictional engagement, whereas FIG. 6 shows the connection region of the bellows 10 with the pressure piece 5, in which the end of the bellows 10 is formed as a polygonal portion 20, in this case cuboid-shaped in cross section, which is bonded to the pressure piece 5.

Finally, FIG. 7 shows a further variant, in which the connection of the bellows 10 is effected by a tongue-and-groove connection, the pressure piece 5 having a circumferential groove 22 in which the bead-like thickening 21 of the bellows 10 is seated, thereby likewise ensuring axial securing of the bellows 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 brake caliper
2 brake carrier
3 clamping device
4 adjusting spindle
pressure piece
6 adjusting device
7 closure cover
8 collar
9 opening
bellows
11 secondary seal
12 sealing arrangement
13 reinforcement ring
14 support ring
15 bead
16 O-ring
17 support ring
18 collar
19 spring or wire ring
20 polygonal portion
21 bead-like thickening
22 groove

What is claimed is:

1. A disc brake, comprising:
a brake caliper in which two brake pads are arrangeable so as to be pressable against a brake disc in operation, one of the two brake pads on a clamping side is actuatable via at least one axially adjustable adjusting spindle carrying a pressure piece, the adjusting spindle being guided through an opening of a closure cover closing a receiving chamber of the brake caliper, thereby forming an annular gap;
a sealing arrangement configured to seal the receiving chamber in a region of the opening, which sealing arrangement bears, on the one hand, against the pressure piece and, on the other hand, is held at an inner side of a collar that circumferentially delimits the opening and extends axially,
wherein the sealing arrangement comprises a bellows and a concentrically arranged secondary seal, the secondary seal and the bellows being formed integrally,
wherein the secondary seal, which has a central opening and is more dimensionally stable than the bellows, has a circumferential wall which is fastened by frictional engagement or by a material bond to the inner side of the collar, a bottom angled relative to the circumferential wall of the secondary seal bearing with an edge delimiting the central opening, formed as a bead, against the adjusting spindle, and
wherein the bellows is connected, with an end formed as a thickened portion opposite the circumferential wall of the secondary seal, to the pressure piece by positive engagement, material bonding, or frictional engagement.

2. The disc brake as claimed in claim 1, wherein the secondary seal is pot-shaped.

3. The disc brake as claimed in claim 1, wherein
the thickened portion of the bellows bearing against the pressure piece comprises a support ring with which the thickened portion is pressable against the pressure piece, and/or
the end region of the secondary seal bearing frictionally against the collar comprises a dimensionally stable reinforcement ring.

4. The disc brake as claimed in claim 1, wherein
the thickened portion of the bellows bearing against the pressure piece is formed as an O-ring.

5. The disc brake as claimed in claim 1, wherein
a support ring is fastened at the pressure piece, against which the thickened portion bears for axial securing of the bellows.

6. The disc brake as claimed in claim 1, wherein
the adjusting spindle has, at an end region facing the pressure piece, a circumferential collar against which the thickened portion bears.

7. The disc brake as claimed in claim 1, wherein
a spring or wire ring is embedded in the end region of the bellows bearing against the pressure piece for frictional retention of the bellows at the pressure piece.

8. The disc brake as claimed in claim 1, wherein
the thickened portion of the bellows bearing against the pressure piece is formed as a polygonal portion in cross-section, which is bonded to the pressure piece.

9. The disc brake as claimed in claim 1, wherein
the bellows is connected to the pressure piece by a tongue-and-groove connection.

10. The disc brake as claimed in claim 1, wherein
the pressure piece has a circumferential groove in which a bead-shaped thickening of the bellows is seated.

11. The disc brake as claimed in claim 1, wherein
the sealing arrangement is a two-component injection molded sealing arrangement.
